(19) United States
(12) Patent Application Publication
(10) Pub. No.: US 2010/0159316 A1
(43) Pub. Date: Jun. 24, 2010

(54) Secondary battery module

(76) Inventors: Sang-Eun Cheon, Suwon-si (KR); Tatsuya Hashimoto, Suwon-si (KR); Seok-Yoon Yoo, Suwon-si (KR); Chi-Young Lee, Suwon-si (KR); Dong-Wook Kim, Suwon-si (KR); Dong-Hyun Lee, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/654,409

(22) Filed: Dec. 18, 2009

(30) Foreign Application Priority Data
Dec. 22, 2008 (KR) 10-2008-0131355

(51) Int. Cl. H01M 10/50; H01M 10/02

(52) U.S. Cl. 429/120; 429/158

(57) ABSTRACT

A secondary battery module including a plurality of unit batteries that each include a cap plate and a case connected to either one of a positive electrode and a negative electrode of an electrode assembly and an electrode terminal connected to the other of the positive electrode and negative electrode, wherein the electrode terminal protrudes outside of a unit battery by passing through the cap plate covering the case, and a connector having a first end and a second end, wherein the first end fits on the electrode terminal of one of the unit batteries and is screw-engaged to the electrode terminal by a nut and the second end is connected to the case of another adjacent unit battery.

### BACKGROUND

1. Technical Field

Embodiments relate to a secondary battery module, and more particularly, to a secondary battery module that enhances a structure of a connector for electrically connecting unit batteries and an arrangement of the unit batteries.

2. Description of the Related Art

Rechargeable batteries may be repeatedly charged and discharged, unlike primary batteries that cannot be repeatedly charged. Low-capacity rechargeable batteries may be used for portable compact electronic apparatuses, e.g., mobile phones, notebook computers and camcorders, and high-capacity rechargeable batteries may be used as a power source for, e.g., driving a motor of a hybrid vehicle, etc.

Recently, a high-output rechargeable battery using a non-aqueous electrolyte having high energy density has been developed. The high-output rechargeable battery may be configured with high capacity by, e.g., connecting a plurality of unit rechargeable batteries in series so as to be used for driving a motor for an apparatus requiring a large amount of power, e.g., an electric vehicle, etc.

For example, a secondary battery module may be formed by connecting a plurality of rechargeable batteries, i.e., the unit batteries, in series. The unit batteries may have, e.g., a cylindrical shape, a prismatic shape, etc.

The unit battery may include an electrode assembly formed of a positive electrode and a negative electrode with a separator interposed therebetween, a case incorporating the electrode assembly, a cap plate sealing the case and electrode terminals that are electrically connected to the electrode assembly and protrude out of the cap plate.

For example, the electrode terminal may include a positive terminal and a negative terminal that are connected to the positive electrode and the negative electrode of the electrode assembly, respectively. Since the secondary battery module may have a barrier rib formed between the unit batteries, the secondary battery module may radiate heat through a surface of the case and the barrier rib.

Positive terminals and negative terminals of adjacent unit batteries may be electrically connected to each other by a bus bar.

Each secondary battery module may include the positive terminal and the negative terminal and may have a disadvantage of making a connection structure of the unit batteries and an arrangement of the unit batteries difficult by connecting the positive terminal and the negative terminal to each other by using the bus bar.

### SUMMARY

Embodiments are therefore directed to a secondary battery module, which substantially overcomes the problems due to the limitations and disadvantages of the related art.

It is therefore a feature of an embodiment to provide a secondary battery module having a simplified structure of connectors for electrically connecting unit batteries and an arrangement of the unit batteries.

At least one of the above and other features and advantages may be realized by providing a secondary battery module, including a plurality of unit batteries that each include a cap plate and a case connected to either one of a positive electrode and a negative electrode of an electrode assembly and an electrode terminal connected to the other of the positive electrode and negative electrode, wherein the electrode terminal protrudes outside of a unit battery by passing through the cap plate covering the case, and a connector having a first end and a second end, wherein the first end fits on the electrode terminal of one of the unit batteries and is screw-engaged to the electrode terminal by a nut and the second end is connected to the case of another adjacent unit battery.

The case may include a plurality of ribs on one side thereof so as to form a flow passage of a heat transfer medium between the unit batteries adjacent to each other.

The ribs may extend in a vertical direction and may be arranged at a predetermined interval in a horizontal direction substantially orthogonal to the vertical direction.

The case may include a plate part and a rib part, wherein the plate part may be adjacent to the electrode terminal and does not include the ribs, and the rib part may be below the plate part and includes the ribs.

The case and the ribs may be a monolithic injection-molded unit.

The connector may include a horizontal part having a through-hole coupled to the electrode terminal of one of the unit batteries and a vertical part bent substantially perpendicular to the horizontal part and welded to the side of the case of an adjacent unit battery.

The horizontal part may have a length from the center of the electrode terminal equal to at least about a sum of ½ the width of the unit battery plus the width of the ribs between a unit battery and another adjacent unit battery.

### BRIEF DESCRIPTION OF THE DRAWINGS

The above and other features and advantages will become more apparent to those of ordinary skill in the art by describing in detail exemplary embodiments thereof with reference to the attached drawings, in which:

FIG. 1 illustrates a partial perspective view of a secondary battery module according to an embodiment;

FIG. 2 illustrates a plan view of the secondary battery module shown in FIG. 1;

FIG. 3 illustrates a cross-sectional view taken along line of FIG. 1;

FIG. 4 illustrates an exploded perspective view of an electrode terminal and a connector;

### DETAILED DESCRIPTION

Korean Patent Application No. 10-2008-0131355, filed on Dec. 22, 2008, in the Korean Intellectual Property Office, and entitled: “Secondary Battery Module,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of:” For example, the expression “at least one of A, B, and C” may also include an n^{th} member, where n is greater than 3, whereas the expression “at least one selected from the group consisting of A, B, and C” does not.

As used herein, the expression “or” is not an “exclusive or” unless it is used in conjunction with the term “either.” For example, the expression “A, B, or C” includes A alone; B alone; C alone; both A and B together; both A and C together; both B and C together; and all three of A, B, and C together, whereas the expression “either A, B, or C” means one of A alone, B alone, and C alone, and does not mean any of both A and B together; both A and C together; both B and C together; and all three of A, B, and C together.

As used herein, the terms “a” and “an” are open terms that may be used in conjunction with singular items or with plural items. For example, the term “a metal” may represent a single compound, e.g., aluminum, or multiple compounds in combination, e.g., aluminum mixed with iron.

According to an embodiment, unit batteries may be arranged adjacent to each other in a way in which a case may be connected to a positive electrode of an electrode assembly and an electrode terminal may be connected to a negative electrode of the electrode assembly and in which one side of a connector may be fixed to the electrode terminal and the other side may be welded to the case, thereby simplifying the structure of the connector and arrangement of the unit batteries. Accordingly, an electrical connection structure of unit batteries and a structure of a secondary battery module may be simplified.

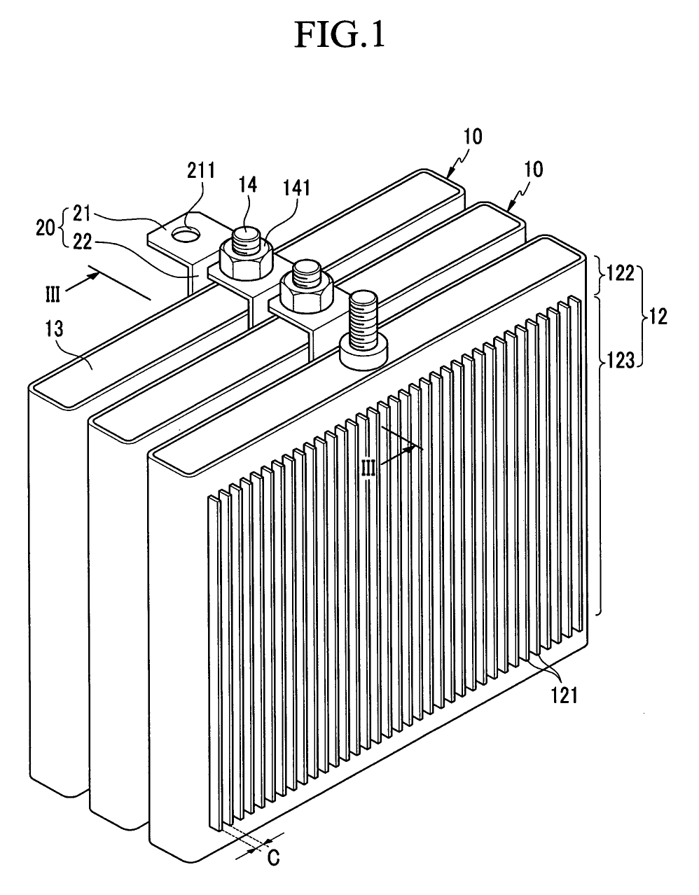

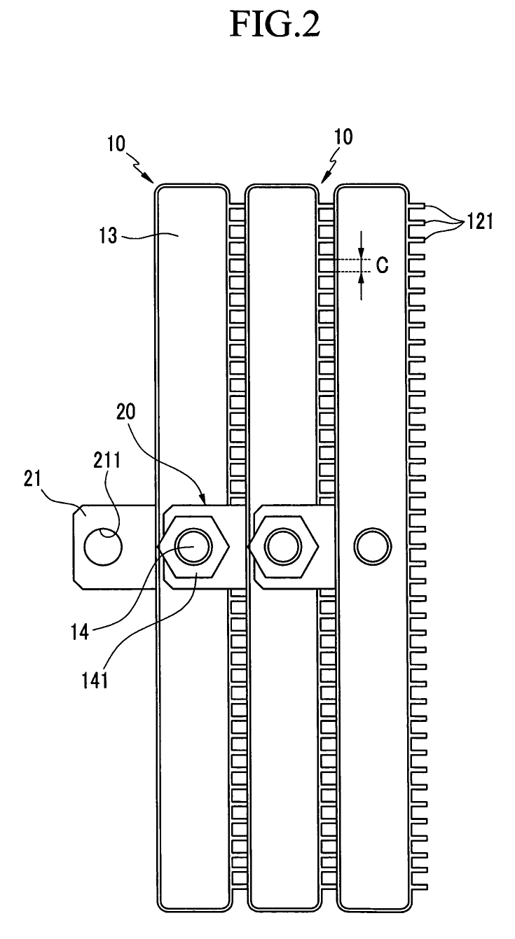

FIG. 1 illustrates a partial perspective view of a secondary battery module according to an embodiment and FIG. 2 illustrates a plan view of the secondary battery module shown in FIG. 1.

Referring to FIGS. 1 and 2, a secondary battery module 100 may include a plurality of unit batteries 10, and may have a high-capacity structure by connecting adjacent unit batteries 10 in series by means of connectors 20.

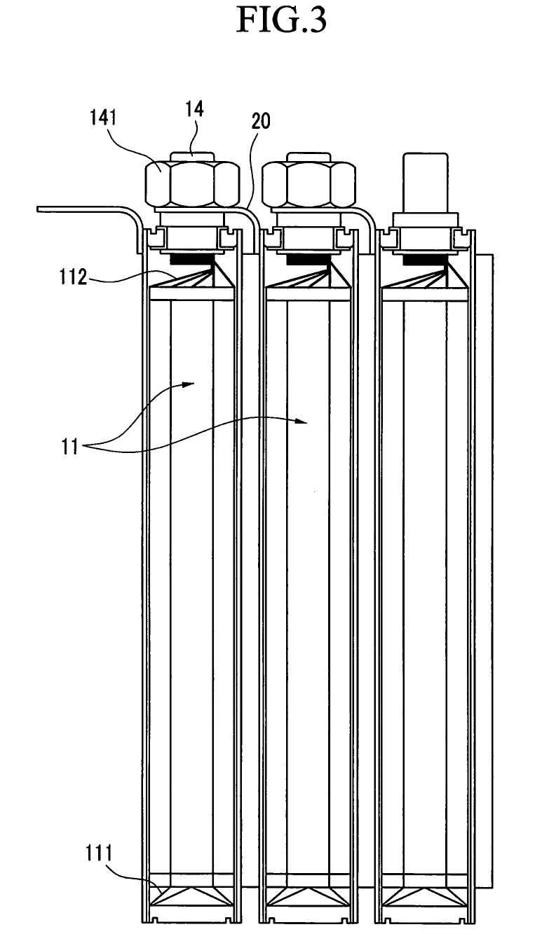

FIG. 3 illustrates a cross-sectional view taken along line of FIG. 1. Referring to FIG. 3, the unit battery 10 may include an electrode assembly 11, a case 12, a cap plate 13 and an electrode terminal 14.

The electrode assembly 11 may include a positive electrode and a negative electrode on respective surfaces of a separator interposed therebetween. For convenience, the electrode assembly 11 may be connected to a positive electrode lead member 111 and a negative electrode lead member 112 that may be connected to the positive electrode and the negative electrode, respectively, as shown in FIG. 3.

The case 12 may incorporate the electrode assembly 11 therein by forming a space. The cap plate 13 may be joined to the case 12 and may seal the case 12 incorporating the electrode assembly 11. An electrode terminal 14 may protrude to the outside of the cap plate 13. The electrode terminal 14 may be insulated from the cap plate 13.

In the electrode assembly 11, the positive electrode may be connected to the case 12 and the negative electrode may be connected to the electrode terminal 14. Therefore, the case 12 may serve as a positive terminal and the electrode terminal 14 may serve as a negative terminal. Alternatively, in the electrode assembly, the negative electrode may be connected to the case and the positive electrode may be connected to the electrode terminal.

Embodiments relate to a structure in which the unit batteries 10 are connected to each other in series. Since an embodiment may adopt various electrode assemblies 11, a detailed description of the electrode assembly 11 will be omitted.

The case 12 may include a conductive metal, e.g., aluminum, an aluminum alloy, or nickel-plated steel, and may have, e.g., a hexahedral prismatic shape or other shapes, so as to have an inner space where the electrode assembly 11 may be positioned.

The case 12 may include ribs 121 at one side thereof. The case 12 and the ribs 121 may be integrally fabricated by, e.g., injection molding, such that it may be possible to minimize costs while improving heat radiating performance of the unit batteries 10.

The ribs 121 may provide a flow passage of a heat transfer medium between the unit batteries 10 disposed adjacent to each other, i.e., between adjacent cases 12, to effectively radiate heat of the unit batteries 10 together with the case 12.

Referring back to FIG. 1, the ribs 121 may extend in a vertical direction and may be arranged at a predetermined interval C in a horizontal direction substantially orthogonal to the vertical direction. Thus, the intervals C between the adjacent cases 12 and between the ribs 121 may restrict the flow passage.

Further, the ribs 121 may be formed on the entire surface of the one side of the case 12 (not shown), but alternatively the ribs 121 may be formed on only a part of the one side.

Thus, the case 12 may include a plate part 122 and a rib part 123 that are partitioned depending on formation of the ribs 121. The plate part 122 may be disposed in an upper part adjacent to the electrode terminal 14, and may not have the ribs 121. The rib part 123 may be disposed in a lower part of the plate part 122, and may have the ribs 121.

Since the ribs 121 may be formed at one side of the case 12 and may not be formed at the other side of the case 12, the unit batteries 10 may be alternately disposed such that the interval C between the ribs 121 may be formed between the unit batteries 10. That is, the flow passage having the interval C may be formed between the unit batteries 10.

The cap plate 13 may seal an opening at one side of the case 12, and the electrode terminal 14 may protrude at the center of the cap plate 13. In the unit battery 10 of an embodiment, since the case 12 may be connected to the positive electrode to serve as the positive terminal, only one electrode terminal 14 connected to the negative electrode may protrude outside of the cap plate 13. The electrode terminal 14 may be insulated from the cap plate 13.

Thus, the unit batteries 10 may be connected with each other in series by connecting the case 12 of one unit battery with the electrode terminal 14 of another adjacent unit battery. As a result, the connection structure of the unit batteries 10 and the arrangement of the unit batteries 10 may be simplified.

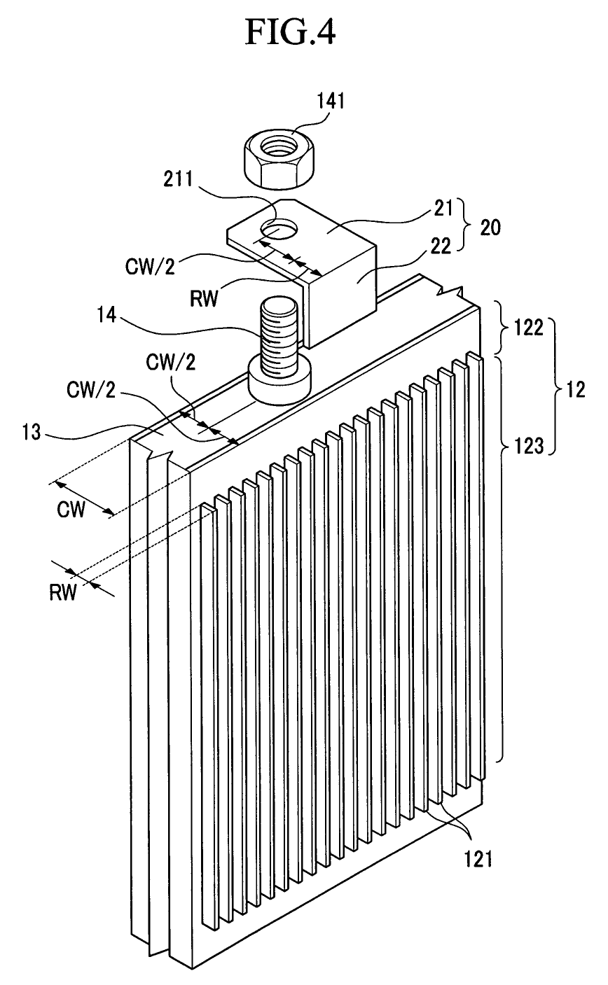

FIG. 4 illustrates an exploded perspective view of an electrode terminal and a connector. Referring to FIG. 4, each connector 20 may be configured to connect adjacent unit batteries 10 in series.

Thus, one end of the connector 20 may be fixed to the electrode terminal 14 by a nut 141 that may be screw-engaged in the electrode terminal 14, and the other end of the connector 20 may be connected to the case 12 by being, e.g., welded to the case 12. The connector 20 that is fixed to the electrode terminal 14 of one unit battery 10 may be connected to the side of the case of another unit battery 10 at which the ribs 121 are not formed.

More specifically, the connector 20 may include a horizontal part 21 fixed to the electrode terminal 14 and a vertical part 22 connected to the case 12.

The horizontal part 21 may be substantially parallel to the cap plate 13, and may have a through-hole 211 in which the electrode terminal 14 may be inserted and may be fixed to the electrode terminal 14 by screw-engaging the nut 141 to the electrode terminal 14.

The vertical part 22 may be bent in a vertical direction with respect to the horizontal direction 21 and welded to the side of the case 12 of an adjacent unit battery. As such, the electrode terminal 14 of one of the unit batteries and the case 12 of an adjacent unit battery may be connected with each other through the connector 20 that includes the horizontal part 21 and the vertical part 22, thereby simplifying the connection structure of the unit batteries 10.

The horizontal part 21 may have a length from the center of the electrode terminal 14 that is equal to at least a sum CW/2+RW, where CW/2 is ½ of the overall width CW of the unit battery 10 (to the center of the electrode terminal 14) and RW is the width of the ribs 121 formed at one side of the case 12 of each unit battery 10.

Therefore, by the size of the horizontal part 21, in a state in which the horizontal part 21 of the connector 20 is fixed to the electrode terminal 14 and the vertical part 22 is welded to the case 12, unnecessary stress may not be applied between adjacent unit batteries 10 connected to the connector 20.

Further, since the connector 20 may be exposed to an upper part of a flow passage by the rib 121, the connector 20 may be effectively cooled by flow of the heat transfer medium; and the electrode terminal 14 that is connected to the connector 20 may also be subjected to a cooling effect achieved by the flow of the heat transfer medium.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A secondary battery module, comprising:
a plurality of unit batteries that each include a cap plate and a case connected to either one of a positive electrode and a negative electrode of an electrode assembly and an electrode terminal connected to the other of the positive electrode and negative electrode, wherein the electrode terminal protrudes outside of a unit battery by passing through the cap plate covering the case; and
a connector having a first end and a second end, wherein the first end fits on the electrode terminal of one of the unit batteries and is screw-engaged to the electrode terminal by a nut and the second end is connected to the case of another adjacent unit battery.

2. The secondary battery module as claimed in claim 1, wherein the case includes a plurality of ribs on one side thereof so as to form a flow passage of a heat transfer medium between the unit batteries adjacent to each other.

3. The secondary battery module as claimed in claim 2, wherein the ribs extend in a vertical direction and are arranged at a predetermined interval in a horizontal direction substantially orthogonal to the vertical direction.

4. The secondary battery module as claimed in claim 2, wherein the case includes a plate part and a rib part, wherein the plate part is adjacent to the electrode terminal and does not include the ribs, and the rib part is below the plate part and includes the ribs.

5. The secondary battery module as claimed in claim 2, wherein the case and the ribs are a monolithic injection-molded unit.

6. The secondary battery module as claimed in claim 1, wherein the connector includes a horizontal part having a through-hole coupled to the electrode terminal of one of the unit batteries and a vertical part bent substantially perpendicular to the horizontal part and welded to the side of the case of an adjacent unit battery.

7. The secondary battery module as claimed in claim 6, wherein the horizontal part has a length from the center of the electrode terminal equal to at least about a sum of ½ the width of the unit battery plus the width of the ribs between a unit battery and another adjacent unit battery.
